(19) United States
(12) Patent Application Publication
(10) Pub. No.: US 2014/0358523 A1
(43) Pub. Date: Dec. 4, 2014

(54) TOPIC-SPECIFIC SENTIMENT EXTRACTION

(71) Applicants: Amit P. Sheth, Dayton, OH (US); Wenbo Wang, Beavercreek, OH (US); Lu Chen, Beavercreek, OH (US)

(72) Inventors: Amit P. Sheth, Dayton, OH (US); Wenbo Wang, Beavercreek, OH (US); Lu Chen, Beavercreek, OH (US)

(73) Assignee: WRIGHT STATE UNIVERSITY, Dayton, OH (US)

(21) Appl. No.: 14/290,436

(22) Filed: May 29, 2014

Related U.S. Application Data
(60) Provisional application No. 61/829,058, filed on May 30, 2013.

(51) Int. Cl. G06F 17/27

(52) U.S. Cl. CPC G06F 17/2785; G06F 17/2705
USPC 704/9

(57) ABSTRACT

One or more embodiments of techniques or systems for sentiment extraction are provided herein. From a corpus or group of social media data which includes one or more expressions pertaining to a topic, target topic, or a target, one or more candidate expressions may be extracted. Relationships between one or more pairs of candidate expressions may be identified or evaluated. For example, a consistency relationship or an inconsistency relationship between a pair may be determined. A root word database may include one or more root words which facilitate identification of candidate expressions. Among one or more of the root words may be seed words, which may be associated with a predetermined polarity. To this end, polarities may be determined based on a formulation which assigns polarities to a sentiment expression, candidate expressions, or an expression as a constrained optimization problem.

### CROSS-REFERENCE TO RELATED APPLICATIONS

This application claims the benefit of U.S. Provisional Patent Application Ser. No. 61/829,058 (Attorney Docket No. 108231.7PRO) entitled “EXTRACTING TOPIC-SPECIFIC SENTIMENT PHRASES”, filed on May 30, 2013. The entirety of the above-noted application is incorporated by reference herein.

### NOTICE ON GOVERNMENT FUNDING

Aspects of the disclosure were made with government support under Grant/Contract No.: IIS-1111182 awarded by the National Science Foundation. The government has certain rights in the application.

### TECHNICAL FIELD

This disclosure generally relates to extracting sentiments from expressions within a corpus of statements or data, such as social media data.

### BACKGROUND

Generally, with regard to language used in social media, the internet, and the like, a wide, diverse, or informal variety of expressions may be utilized by users or individuals posting content to convey their sentiments. Often, these expressions cannot be trivially enumerated or captured using current or predefined lexical patterns. For example, the informal nature of language usage and writing style in social media or other informal settings poses considerable difficulties for typical parsers, which may rely on standard spelling and/or grammar.

### BRIEF DESCRIPTION

This brief description is provided to introduce a selection of concepts in a simplified form that are described below in the detailed description. This brief description is not intended to be an extensive overview of the claimed subject matter, identify key factors or essential features of the claimed subject matter, nor is it intended to be used to limit the scope of the claimed subject matter.

One or more embodiments of techniques or systems for sentiment extraction are provided herein. For example, according to one or more aspects, an optimization based approach is provided to extract phrase-level sentiment expressions for a target (e.g., a movie, a person, or other subject) from a corpus or group of social media data (e.g., microblogs, tweets, reviews, posts, statements, etc.). One or more of the sentiment expressions, phrases, or expressions may be aggregated from a corpus, group, or body of social media data. One or more of the phrases or expressions may be associated with one or more targets. For example, a group of social media data or social media posts may pertain to a particular subject, topic, or target, such as an actor, a movie, or other subject. One or more candidate phrases or candidate expressions may be extracted from one or more of these expressions. For example, for a social media post includes an expression, “Just saw Movie X. It was long, but awesome!”, the phrases “awesome” and “long” could be among the candidate expressions extracted from the social media post or the expression based on root words from a root word database, as will be described in greater detail herein.

One or more relationships between one or more pairs of candidate expressions may be identified. Here, in this example, an inconsistency relation may exist between the terms or candidate expressions “awesome” and “long” due to the “but” language or terminology which separates the two terms or candidate expressions. A polarity may be determined for one or more topics associated with a sentiment expression or a candidate expression. In one or more embodiments, a polarity, target-specific polarity, or target-dependent polarity of a sentiment expression, candidate expression, or expression may be assessed. For example, a polarity of an expression may be determined based on a nature of a target, subject, target topic, an individual topic, a set or group of related topics within a domain or universe. Here, “long” may be associated with a negative polarity while “awesome” may be associated with a positive polarity. In one or more embodiments, the polarity may be determined based on a formulation which assigns polarities to a sentiment expression, candidate expressions, or an expression as a constrained optimization problem across a group of social media data, as will be described herein.

Accordingly, the determined polarities facilitate recognition of a diverse or richer set of sentiment-bearing expressions, including formal words, formal phrases, slang words, slang phrases, or other phrases which are not necessarily limited to pre-specified syntactic patterns or merely single words. Further, sentiment extraction may be provided such that one or more sentiments may be associated with one or more topics from a sentiment expression or expression. In other words, if an expression has multiple targets, subjects, or topics, respective targets may be associated with corresponding sentiments, rather than merely assigning a single sentiment to an expression when different portions of an expression may refer to different targets or subjects.

The following description and annexed drawings set forth certain illustrative aspects and implementations. These are indicative of but a few of the various ways in which one or more aspects may be employed. Other aspects, advantages, or novel features of the disclosure will become apparent from the following detailed description when considered in conjunction with the annexed drawings.

### BRIEF DESCRIPTION OF THE DRAWINGS

Aspects of the disclosure are understood from the following detailed description when read with the accompanying drawings. Elements, structures, etc. of the drawings may not necessarily be drawn to scale. Accordingly, the dimensions of the same may be arbitrarily increased or reduced for clarity of discussion, for example.

FIG. 1 is an illustration of an example component diagram of a system for sentiment extraction, according to one or more embodiments.

FIG. 2 is an illustration of an example flow diagram of a method for sentiment extraction, according to one or more embodiments.

FIG. 3 is an illustration of an example flow diagram of a method for sentiment extraction, according to one or more embodiments.

FIG. 4 is an illustration of an example approach to sentiment extraction, according to one or more embodiments.

FIG. 5 is an illustration of an example computer-readable medium or computer-readable device including processor-executable instructions configured to embody one or more of the provisions set forth herein, according to one or more embodiments.

FIG. 6 is an illustration of an example computing environment where one or more of the provisions set forth herein are implemented, according to one or more embodiments.

### DETAILED DESCRIPTION

Embodiments or examples, illustrated in the drawings are disclosed below using specific language. It will nevertheless be understood that the embodiments or examples are not intended to be limiting. Any alterations and modifications in the disclosed embodiments, and any further applications of the principles disclosed in this document are contemplated as would normally occur to one of ordinary skill in the pertinent art.

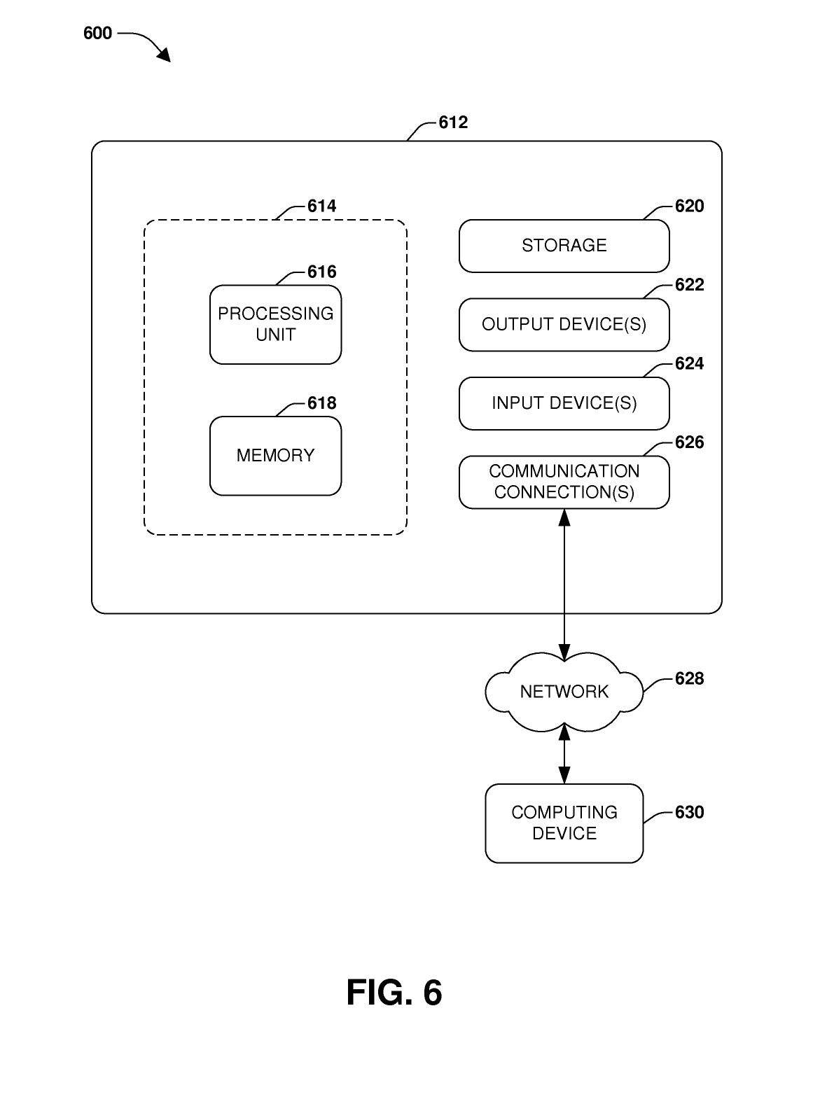

For one or more of the figures herein, one or more boundaries, such as boundary 614 of FIG. 6, for example, may be drawn with different heights, widths, perimeters, aspect ratios, shapes, etc. relative to one another merely for illustrative purposes, and are not necessarily drawn to scale. For example, because dashed or dotted lines may be used to represent different boundaries, if the dashed and dotted lines were drawn on top of one another they would not be distinguishable in the figures, and thus may be drawn with different dimensions or slightly apart from one another, in one or more of the figures, so that they are distinguishable from one another. As another example, where a boundary is associated with an irregular shape, the boundary, such as a box drawn with a dashed line, dotted lined, etc., does not necessarily encompass an entire component in one or more instances. Conversely, a drawn box does not necessarily encompass merely an associated component, in one or more instances, but may encompass a portion of one or more other components as well.

The following terms are used throughout the disclosure, the definitions of which are provided herein to assist in understanding one or more aspects of the disclosure.

As used herein, the term “expression” may generally refer to or include a sentiment expression. Examples of sentiment expressions may include sentiment words or phrases in social media posts, tweets, user generated web content, other web content, etc. An expression generally includes a set of one or more words. Subsets of words may be selected to form one or more candidate expressions, which are portions of corresponding expressions.

As used herein, the term “target” may generally refer to or include a target topic, a topic, a subject, etc.

As used herein, the term “infer” or “inference” generally refer to the process of reasoning about or inferring states of a system, a component, an environment, a user from one or more observations captured via events or data, etc. Inference may be employed to identify a context or an action or may be employed to generate a probability distribution over states, for example. An inference may be probabilistic. For example, computation of a probability distribution over states of interest based on a consideration of data or events. Inference may also refer to techniques employed for composing higher-level events from a set of events or data. Such inference may result in the construction of new events or new actions from a set of observed events or stored event data, whether or not the events are correlated in close temporal proximity, and whether the events and data come from one or several event and data sources.

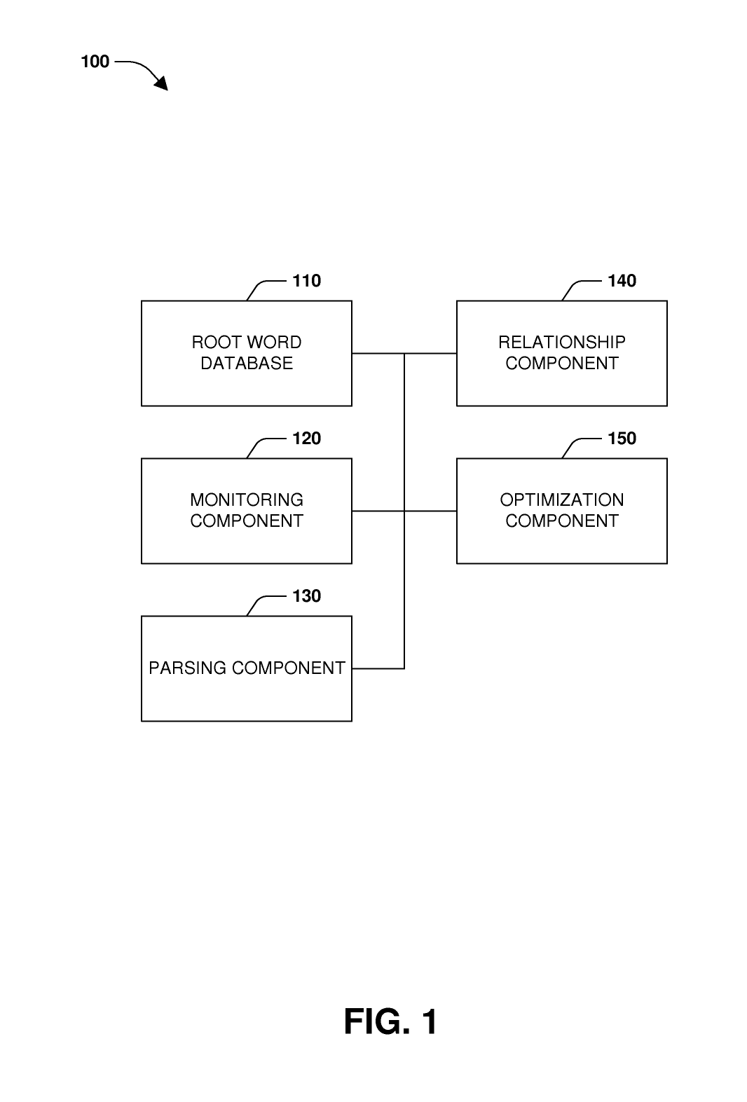

FIG. 1 is an illustration of an example component diagram of a system 100 for sentiment extraction, according to one or more embodiments. The system 100 for sentiment extraction may include a root word database 110, a monitoring component 120, a parsing component 130, a relationship component 140, and an optimization component 150. The system 100 facilitates extraction of sentiments or sentiment expressions from one or more expressions and assessing corresponding polarities for a target from a corpus or group of social media data (e.g., tweets, posts, statements, or other user content).

The root word database 110 may be a database which is built or created by aggregating or collecting one or more root words from one or more sources. A root word may be a word which is sentiment bearing. For example, “good”, “bad”, “awesome”, “terrible”, etc. may be among one or more words from the root word database 110. In other words, a root word of the root word database 110 may have or be associated with a feeling, an emotion, or an opinion in general, towards a situation, or towards an event. A source may include one or more sentiment lexicon sources, one or more dictionaries, one or more synonyms, one or more slang resources, one or more lexical resources, etc. Further, one or more of the sources may provide one or more root words which contain or include variations of one or more root words, either slang or formal, etc. As an example, “good” may be spelled “gud”. To this end, “gud” may be included as a root word within the root word database 110.

Further, the root word database 110 may include one or more root words which are seed words. A seed word may be associated with a predetermined positive polarity probability or a predetermined negative polarity probability. For example, “awesome” may be a seed word within the root word database 110 which is associated with a positive polarity probability of ‘1’ and a negative polarity probability of ‘0’. Conversely, the word “terrible” may be a seed word which is associated with a positive polarity probability of ‘0’ and a negative polarity probability of ‘1’. Here, a positive polarity probability of ‘1’ may mean that the word “awesome” is defined as positive, while a negative polarity probability of ‘1’ for the word “terrible” may mean that “terrible” is defined as negative. In this example, polarity probabilities may span between ‘0’ and ‘1’, inclusively. Accordingly, one or more positive polarity probabilities may be indicative of a probability that a corresponding candidate expression is positive or has positive sentiments. Similarly, one or more negative polarity probabilities may be indicative of a probability that a corresponding candidate expression is negative or has negative sentiments.

As an example, the root word database 110 may be built by initializing a query set Q with one or more seed words. For a word w in the query set Q, one or more related words may be obtained. A set of related words may be treated as a “document”. A frequency matrix may be created to record the frequency of the co-occurrence of pairs of words in one or more of the “documents”. The frequency matrix may be updated when new documents are obtained or when new sets of related words are obtained. The query set Q may be updated by removing w or including related words in respective “documents”. In this way, merely words that have not been added to the query set Q are added to Q. This may be recursively repeated until Q is empty. One or more slang words may be identified based on a dominant polarity of related sentiment words which frequently co-occur with the word in the frequency matrix. These slang words may be added to the root word database 110. For example, “rockin” frequently co-occurs with “amazing”, “sexy”, “sweet”, “great”, and “awesome”. Since these words are associated with positive polarities, “rockin” may be identified as positive or having a positive polarity, and added to the root word database 110 or a root word set of the root word database 110. In other embodiments, positive or negative polarity probabilities may be imported or received from one or more of the sources for one or more of the seed words.

The root word database 110 may be utilized to facilitate extraction of one or more candidate expressions from a corpus of expressions or social media data. In other words, sentiment bearing root words may be utilized to extract candidate expressions. The monitoring component 120 may receive one or more of these expressions. These expressions may be received or aggregated from most any social media source or web source, such as a social media feed, microblogging service, text messages, social media messages, messages, servers, social media service, media sharing service, social media data, etc. Regardless, one or more of the expressions received by the monitoring component 120 may include a set of one or more words. Often, when users post content or author a message or a post, their expressions may include sentiments directed toward a target, a topic, subject, or a target topic. Accordingly, the monitoring component 120 may receive expressions which are associated with a target or a particular subject.

For example, the monitoring component 120 may receive a plurality of expressions or one or more expressions which relate to or are associated with a single target, such as a movie, an actor, etc. In this way, these expressions may be analyzed within a universe, such as a universe of movies or a universe of people, etc. In other words, by receiving expressions related to a target, the monitoring component 120 may ensure that the sentiment extraction of the system 100 accounts for meanings of words within multiple universes. As an example, the word or term “predictable” may be positive in the stock market universe, but viewed negatively in the movie universe. To this end, expressions pertaining to movies may be analyzed separately from expressions which relate to the stock market.

Alternatively or in other embodiments, the monitoring component 120 may receive one or more expressions associated with one or more targets. These expressions may be sorted or binned into one or more groups which correspond to different universes and analyzed accordingly. As a result of this, the monitoring component 120 enables the system 100 to categorize or assign polarities to candidate expressions or expressions in a manner such that respective polarities are sensitive to a target. Returning to the example where “predictable” may be utilized in two different contexts or universes (e.g., a stock market universe and a movie universe), “predictable” may be negative towards a target movie in the movie universe while being indicative of positive sentiment regarding other targets in the stock or stock market universe. In this way, the monitoring component 120 may utilize an algorithm which is capable of extracting candidate expressions or sentiments associated with respective targets and assessing target-dependent polarities.

The parsing component 130 may extract one or more candidate expressions from one or more of the expressions received by the monitoring component 120. The parsing component 130 may identify one or more targets, universes, or domains associated with respective candidate expressions. Candidate expressions may include a subset of one or more words of the set of one or more words of corresponding expressions or sentiment expressions. Additionally, candidate expressions may include a root word from the root word database 110. In one or more embodiments, the parsing component 130 may extract one or more candidate expressions from an expression or a sentiment expression by taking or extracting one or more n-grams from corresponding expressions. In other words, candidate expressions may be most any on target n-gram(s), such as an n-gram containing or including at least one root word.

An n-gram may be a contiguous sequence of words from an expression. Further, one or more n-grams may be extracted from an expression such that one or more of the n-grams includes at least one root word from the root word database 110. In other words, one or more of the candidate expressions may be extracted based on n-grams which include root words. Stated yet another way, respective candidate expressions may be selected or organized such that each candidate expression has a root word in the candidate expression, thus making respective candidate expressions indicative of at least some sentiment which pertains to or applies to a target. As an example, for the expression, “Saw Movie X. So predictable! I want my money back”, “predictable”, “want”, “want my”, “want my money”, and “want my money back” would be possible candidate expressions (e.g., where “want” is a root word). In this way, the parsing component 130 enables sentiment of phrases to be extracted. Because n-grams which include or contain multiple words (e.g., multiple or different length candidate expressions) may be extracted, multi-word phrases may be analyzed or weighted (e.g., with polarities, etc.). Accordingly, this enables sentiment to be extracted in a diverse manner. Further, because the root word database 110 may include one or more root words from urban dictionaries or variations on spelling, formal words, slang words, etc., the system 100 may account for or analyze expressions or candidate expressions accordingly.

The parsing component 130 may extract one or more candidate expressions from a corresponding expression by performing sentence splitting on the corresponding expression. Additionally, the parsing component 130 may determine one or more dependency relations between one or more root words and a target based on the sentence splitting. A dependency relation may be determined based on syntactic theory or a clause structure where words or syntactic units are related (e.g., to a verb). In other words, the parsing component 130 may extract one or more candidate expressions based on a root word and a target (e.g., subject). Further, the parsing component 130 may extract candidate expressions based on a proximity between a root word and a target. For example, candidate expressions may be selected to have up to an n-word range between the root word and the target, where n is an integer number. Regardless, the parsing component 130 may employ one or more extraction algorithms to determine one or more of the candidate expressions in a manner which accounts for such diversity, such as n-gram candidate expressions or sentiment associated with multi-word phrases. Explained yet another way, the parsing component 130 may connect one or more candidate expressions with one or more consistency relations or one or more inconsistency relations. Accordingly, it can be seen that root words may be utilized for selection of candidate expressions, but assessment of polarities of candidate expressions may be achieved in a target-dependent manner based on candidate expressions across a corpus of social media data or a group of social media data.

In one or more embodiments, to extract one or more candidate expression associated with a target from one or more expressions, root words within respective expressions may be identified by the parsing component 130. For example, root words which act on a target may be identified. As mentioned, sentence splitting, stemming, removing of “stop words” (e.g., a, an, the, etc.), and parsing may be employed by the parsing component 130 to determine a dependency relation between two or more words of an expression (e.g., between a word and a target). The parsing component 130 may determine that a root word is on-target if there is a dependency relation between the word and the target. The parsing component 130 may determine that a root word is on-target if the word is within a proximity range of the target, such as within four words of the target, for example. Further, the parsing component 130 may be adjusted to relax dependency relations to mitigate missing proper expression, such as due to informal language use, etc. Regardless, after on-target root words are selected, n-gram selection based on the on-target root words may be done. In one or more embodiments, n-grams may be selected in accordance with a threshold n-gram length, such as a threshold length<=5, for example. (In other words, n-grams of this example may include no more than 5 words, although most any number may be implemented as a threshold).

It will be appreciated that because n-grams may be utilized, the system 100 may account for negations, conjunctions, position relations, overlap, containment, etc. within an expression.

The relationship component 140 may identify one or more inter-expression relations for an expression. To this end, an expression may have or include multiple candidate expressions, where one or more of the candidate expressions may be indicative or express different sentiments regarding a single target. For example, the expression, “Movie X was long, but good” has two different sentiments—“long” and “good”. Here, “long” and “good” may be two different candidate expressions. However, because these candidate expressions are separated by the word “but”, these two candidate expressions appear to be inconsistent. In other words, an inconsistency relation exists between the pair of candidate expressions of “long” and “good”. Accordingly, in some scenarios, two or more candidate expressions (e.g., a pair of candidate expressions or a candidate expression pair) may agree or have a consistency relation, while in other scenarios, candidate expressions may be inconsistent or be associated with an inconstancy relation.

Regardless, the relationship component 140 may identify one or more relationships between candidate expressions, such as by identifying consistency relations or inconsistency relations. Generally, an expression or candidate expression is inconsistent with a negation of the expression or candidate expression. As an example, one or more inconsistency relations between a first candidate expression and a second candidate expression may be identified based on the first candidate expression including a negation and the first candidate expression including or ending with the second candidate expression. For example, for the expression “Movie A was not good”, “good” and “not good” may be the candidate expressions determined for the expression. Here, “not good” includes a negation and also includes “good”, which is the other candidate expression. Accordingly, an inconsistency relation may exist between “good” and “not good”.

It will be appreciated that other inconsistency relations may be determined. Generally, two expressions or candidate expressions linked by a contrasting conjunction is likely to be inconsistent or have an inconsistency relation. For example, the relationship component 140 may identify one or more inconsistency relations between a first candidate expression and a second candidate expression based on an expression including the first candidate expression, a contrasting conjunction (e.g., however, but, although, etc.), a second candidate expression, and a lack of negation applied to both the first candidate expression and the second candidate expression. For example, for the expression “Movie A was long, but good”, “long” and “good” may be the candidate expressions determined for the expression. Because the contrasting conjunction “but” is used to separate the two candidate expressions here and neither “long” nor “good” is negated, an inconsistency relation may be determined between “long” and “good”. Lack of negation or lack of extra negation may mean negation of a first candidate expression or a second candidate expression. For example, for the expression, “She is gud, but I am still not a fan”, “fan” and “not a fan” have an inconsistency relation, and “gud” and “not a fan” have an inconsistency relation as well. Accordingly, “gud” and “fan” are not inconsistent (e.g., do not have an inconsistency relation) since there is extra negation “not” before fan.

The relationship component 140 may identify one or more consistency relations between candidate expressions. For example, a consistency relation may be identified between a first candidate expression and a second candidate expression based on a lack of negation applied to both the first candidate expression and the second candidate expression. For example, for the expression “Movie A was sweet! It was epic!”, “sweet” and “epic” may be the candidate expressions determined for the expression. Here, because neither candidate expression has been negated (e.g., by “not”), a consistency relation may be determined for the candidate expression pair of “sweet” and “epic”.

In one or more embodiments, the relationship component 140 may construct one or more networks corresponding to one or more consistency relations between respective candidate expressions or one or more inconsistency relations between respective candidate expressions. In other words, candidate expressions may be connected via at least two different types of inter-expression relations (e.g., consistency relations or inconsistency relations, which denote whether sentiments of a pair of candidate expressions or a candidate expression pair are consistent such that they are both positive or both negative or inconsistent such that one is positive and the other is negative). It will be appreciated that a network does not necessarily include a graphical representation of data. For example, a network may merely include data associated with one or more nodes or one or more edges within the network. Additionally, network data may include one or more edge weights which correspond to one or more respective edges within the network.

One or more candidate expressions may be represented as one or more nodes of a network. One or more edges may be indicative of a social media post or a statement which includes both nodes associated with or connected by an edge. For example, for an expression, “Movie A was great! It was awesome!”, “great” and “awesome” would be nodes of a network, connected via an edge. When numerous expressions include “great” and “awesome” as candidate expressions, edge weights may be assigned to corresponding edges (e.g., between “great” and “awesome”) which may be indicative of a frequency the candidate expressions appear together in the same expression. For example, if the edge weight between “great” and “awesome” is six, then of a universe of expressions, six expressions related to a target include the terms or candidate expressions “great” and “awesome”. In other words, it may be inferred that the more frequent a candidate expression is connected to a positive polarity node, the more likely that the candidate expression has a positive polarity.

Pairs of candidate expressions having an inconsistency relation may appear in the inconsistency network, while pairs of candidate expressions having a consistency relation may appear in the consistency network. Regardless, the relationship component 140 may, in one or more embodiments, encode one or more relationships into one or more networks. For example, the consistency network may be N^{cons} (P, R^{cons}), where P is a node set where respective nodes represent candidates or candidate expressions and R^{cons} represents a set of weighted edges where respective edges denote or are indicative of a consistency relation between two candidate expressions or corresponding nodes. A weight of an edge may be indicative of a frequency of a consistency relation between two corresponding candidate expressions across a corpus or body of social media data (e.g., expressions of a universe or domain). Similarly, the inconsistency network may be N^{incons} (P, R^{incons}).

It will be appreciated that according to one or more embodiments, the relationship component 140 may encode or create one network which includes one or more consistency relations as well as one or more inconsistency relations. Regardless, the network data may encode correlations of target dependent polarity of candidate expressions over a corpus of social media data. Referring again to a previously discussed example where “predictable” and “want my money back” may be utilized in different contexts, these two candidate expressions are consistent towards a target associated with movies or in a movie universe. In other words, this suggests that “predictable” should have the same polarity as “want my money back”. Explained yet another way, both of these candidate expressions may be negative, for example. If the relationship component 140 builds two networks (e.g., the consistency network and the inconsistency network), the more frequently or more heavily edge weighted “predictable” connects with negative expressions in the consistency network or the more frequently “predictable” connects with positive expressions in the inconsistency network, the more likely the term “predictable” is negative with respect to the target or movie.

Additionally, edges may be created between nodes or candidate expressions when respective candidate expressions do not have other candidate expressions between them in an expression. For example, for an expression, “A B C”, an edge may connect node A and node B and another edge may connect node B and node C. In other words, in some scenarios, an edge may not be created to connect node A and node C because B is in between A and C in the expression.

The optimization component 150 may determine one or more polarities for one or more candidate expressions (e.g., of n number of candidate expressions) based on one or more probabilities that one or more of the candidate expressions are indicative of a positive sentiment (e.g., positive polarity probabilities), one or more probabilities that one or more of the candidate expressions are indicative of a negative sentiment (e.g., negative polarity probabilities), for one or more pairs of candidate expressions: evaluating a probability that a first candidate expression and a second candidate expression have a same polarity, evaluating a probability that a first candidate expression and a second candidate expression have different polarities, and frequencies of relations between respective pairs of candidate expressions (e.g., across one or more expressions within a universe). In this way, the optimization component 150 may facilitate identification of actual expressions of sentiment from social media data or associated expressions, rather than merely classifying a post or a tweet as positive or negative. In other words, because the parsing component 130 may extract one or more candidate expressions from an expression, phrase-level sentiment extraction may be achieved rather than overall sentiment polarity (e.g., classification as merely positive or negative).

A consistency probability may be the probability that the first candidate expression and the second candidate expression have the same polarity. These consistency probabilities (or inconsistency probabilities) may be determined for one or more pairs of candidate expressions (e.g., where the first candidate expression and the second candidate expression form a candidate expression pair). Explained yet another way, one or more consistency probabilities may be indicative of a probability that a corresponding pair of candidate expressions have the same polarity. Similarly, one or more of the inconsistency probabilities may be indicative of a probability that a corresponding pair of candidate expressions have different polarities.

The optimization component 150 may factor frequencies of relations or relationships between pairs of candidate expressions across one or more of the expressions when determining one or more of the polarities. In other words, if “good” and “epic” appear in social media posts, tweets, expression statements, or other expressions frequently, this may impact polarities of neighboring candidate expressions (e.g., in a graph of candidate expressions). The optimization component 150 may utilize the relationship information or network data generated by the relationship component 140 to build an optimization model which may be utilized to estimate target dependent polarities for one or more candidate expressions.

To this end, the optimization component 150 may be configured to minimize an objective function associated with one or more polarities for one or more of the candidate expressions based on one or more positive polarity probabilities for respective candidate expressions, one or more negative polarity probabilities for respective candidate expressions, one or more consistency probabilities for one or more pairs of candidate expressions, one or more inconsistency probabilities for one or more pairs of candidate expressions, and the frequencies of one or more of the relationships between pairs of candidate expressions across one or more of the expressions. In one or more embodiments, the optimization component 150 may minimize the objective function utilizing a Limited-memory Broyden-Fletcher-Goldfarb-Shanno bound-constrained (L-BFGS-B) algorithm or other similar algorithms.

The optimization component 150 may build an optimization model to assess target dependent polarities of one or more candidate expression based on the consistency network data or the inconsistency network data. In other words, rather than evaluating each expression, statement, or post from a social media source as a whole, the optimization component 150 assesses a polarity probability, among other things, for respective candidate expressions. In this way, one or more polarities may be determined accordingly. A polarity probability may be indicative or be a measure of how likely an expression or candidate expression is positive or negative. In one or more embodiments, a candidate expression cᵢ may have a P-probability or positive probability, Pr^{P}(cᵢ). This positive probability may be the probability that the candidate expression cᵢ is indicative of a positive sentiment. Conversely, a candidate expression cᵢ may have an N-probability or negative probability, Pr^{N}(cᵢ). This negative probability may be the probability that the candidate expression cᵢ is indicative of a negative sentiment. If an assumption is made that candidate expressions are positive or negative (e.g., not neutral), Pr^{P}(cᵢ)+Pr^{N}(cᵢ)=1. Accordingly, polarities of expressions or candidate expressions may be determined based on corresponding polarity probabilities (e.g., positive polarity probability or negative polarity probability). For example, an expression or candidate expression having a P-Probability or positive polarity probability of 0.9, and an N-Probability or negative polarity probability of 0.1 may be considered highly positive. An expression having a positive probability and negative probability of 0.45 and 0.55, respectively, may be filtered based on a clarity threshold (e.g., P-Probability or N-Probability>=0.80).

Based on the P-Probability (Pr^{P}(cᵢ)) and N-Probability (Pr^{N}(cᵢ)) of respective candidate expressions, the probability of whether sentiments of two expressions are consistent or inconsistent may be obtained. The consistency probability of two expressions cᵢ and cⱼ may be the probability that they carry the consistent sentiments (e.g., both cᵢ and cⱼ are positive (or negative)). Assuming the polarity probability of cᵢ is independent of cⱼ, the consistency probability is Pr^{P}(cᵢ)Pr^{P}(cⱼ)+Pr^{N}(cᵢ)Pr^{N}(cⱼ). Similarly, the inconsistency probability may the probability that they carry the inconsistent sentiments, or Pr^{P}(cᵢ)Pr^{N}(cⱼ)+Pr^{N}(cᵢ)Pr^{P}(cⱼ). According to one or more embodiments, assessing the polarity of respective candidate expressions may thus be represented as an optimization problem as follows:

$$minimize = \{ {\sum }_{i = 1}^{n - 1} {\sum }_{j > i}^{n} {{ω}_{ij}^{cons} ( 1 - {Pr}^{P} ( {c}_{i} ) {Pr}^{P} ( {c}_{j} ) - {Pr}^{N} ( {c}_{i} ) {Pr}^{N} ( {c}_{j} ) )}^{2} + {{ω}_{ij}^{incons} ( 1 - {Pr}^{P} ( {c}_{i} ) {Pr}^{N} ( {c}_{j} ) - {Pr}^{N} ( {c}_{i} ) {Pr}^{P} ( {c}_{j} ) )}^{2} \}$$

Subject to 0<=Pr^{P}(cᵢ)<=1, 0<=Pr^{N}(cᵢ)<=1, and Pr^{P}(cᵢ)+Pr^{N}(cᵢ)=1, for i=1, 2, . . . n, where ωᵢⱼ^{cons} and ωᵢⱼ^{incons} are the weights of edges (e.g., the frequency of the consistency and inconsistency relations) between cᵢ and cⱼ in networks N^{cons} and N^{incons}.

If a candidate cᵢ is contained in a seed word set S⁰, a P-Probability Pr^{P}(cᵢ) may be set or assigned to 1 (or 0) if cᵢ is positive (or negative) according to S⁰. In other words, seed words of the seed word set, S⁰ may contain or include words or seed words assumed to be positive or negative (e.g., regardless of the targets). To this end, one or more P-Probabilities of other candidates or candidate expressions may be obtained by solving the optimization problem or model as discussed herein. As a result, polarity probabilities may be obtained for candidate expressions which are not necessarily connected with seed words, thereby enabling inference of sentiments associated with these candidate expressions.

As mentioned, the L-BFGS-B algorithm may be employed to solve this constrained optimization problem with simple bounds. For example, gradient projection may be utilized to determine a set of active constraints at respective iterations along with a limited memory BFGS matrix to approximate a Hessian of the objective function. When the P-Probabilities of candidate expressions are provided, optimization may be initiated. Accordingly, P-Probabilities and N-Probabilities may be obtained for respective candidate expressions. In one or more embodiments, candidates with P-Probabilities or N-Probabilities higher than a threshold level (e.g., >=0.80) may be identified as positive or negative expressions. Here, if an expression or candidate expression has a polarity probability below the threshold, that candidate expression may be removed or filtered from results or consideration. For example, “want my”, “want my money”, and “want my money back” may be among one or more candidate expressions. Here, “want my money back” maybe a candidate expression which is associated with a strongest polarity probability or score of one or more candidate expressions of a same n-gram family. To this end, data associated with “want my money back” may be emphasized or selected over the other candidate expressions “want my” or “want my money”.

In some scenarios, irrelevant or undesirable candidate expressions associated with a high polarity probability greater than the threshold level may not be filtered. For example, one reason that an undesirable candidate expression may have a high polarity probability (e.g., greater than a threshold level) is because assessment of the corresponding polarity probability may be based on a small sample size or sparse data. In other words, if a candidate expression merely appears a few times, such as once or twice within a corpus or group of social media data, and coincidentally is consistent with positive expressions, that may result in the candidate expression being assigned a high P-Probability. To this end, a confidence of a polarity assessment may be calculated as follows for respective candidate expressions cᵢ:

$$ɛ ( {c}_{i} ) = \frac{max ( {Pr}^{P} ( {c}_{i} ) , {Pr}^{N} ( {c}_{i} ) ) * df ( {c}_{i} )}{{n}_{words ( {c}_{i} )}}$$

Where df(cᵢ) is the number of expressions containing candidate expression cᵢ and n_{words(c}_{ᵢ}₎ is the number of words within a corresponding expression. It will be appreciated that ε may be biased towards shorter phrases or expressions because short phrases or candidate expressions generally have more relation in networks, such as the consistency network or inconsistency network, thereby making their polarity assessments or assignments more reliable compared to longer candidate expressions.

In one or more embodiments, the optimization component 150 may learn polarities or probabilities associated with one or more candidate expressions and apply these probabilities to new data, social media data, or new expressions. In other words, candidate expressions may be utilized to analyze additional expressions, social media data, or other statements which are incoming or being received, such as by the monitoring component 120. Explained yet another way, probability or polarity data associated with candidate expressions (e.g., or nodes within a corresponding graph) may be utilized to define one or more candidate expressions as a root within the root word database 110 for a given domain or universe. For example, “want my money back” may be determined to be associated with a large N-probability. Upon this determination, “want my money back” may be added to the root word database 110 as a root word, root phrase, or root expression, for example.

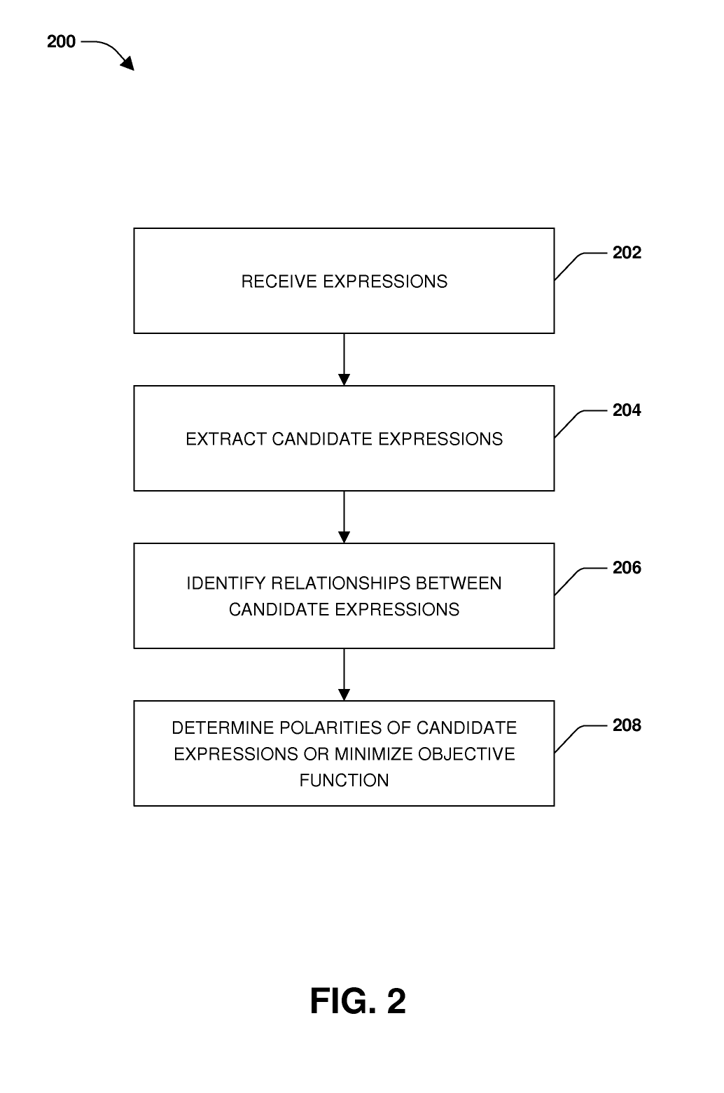

FIG. 2 is an illustration of an example flow diagram of a method 200 for sentiment extraction, according to one or more embodiments. At 202, one or more expressions may be received. For example, one or more expressions may be received, wherein one or more respective expressions includes a set of one or more words. Additionally, one or more of the expressions may be associated with a target. At 204, one or more candidate expression may be extracted. For example, one or more candidate expressions may be extracted from one or more of the expressions, wherein one or more of the candidate expressions includes a subset of the set of one or more words. At 206, one or more relationships between candidate expressions may be identified. For example, relationships may be identified between pairs of candidate expressions as consistency or inconsistency relations. Additionally, frequencies of relationships between pairs of candidate expressions may be tracked or identified across one or more expressions within a universe. At 208, polarities of candidate expressions may be determined or an objective function may be minimized. For example, polarities may be determined or the objective function may be minimized based on one or more positive polarity probabilities for respective candidate expressions, one or more negative polarity probabilities for respective candidate expressions, one or more consistency probabilities for one or more pairs of candidate expressions, one or more inconsistency probabilities for one or more pairs of candidate expressions, and/or the frequencies of one or more of the relationships between pairs of candidate expressions across one or more of the expressions.

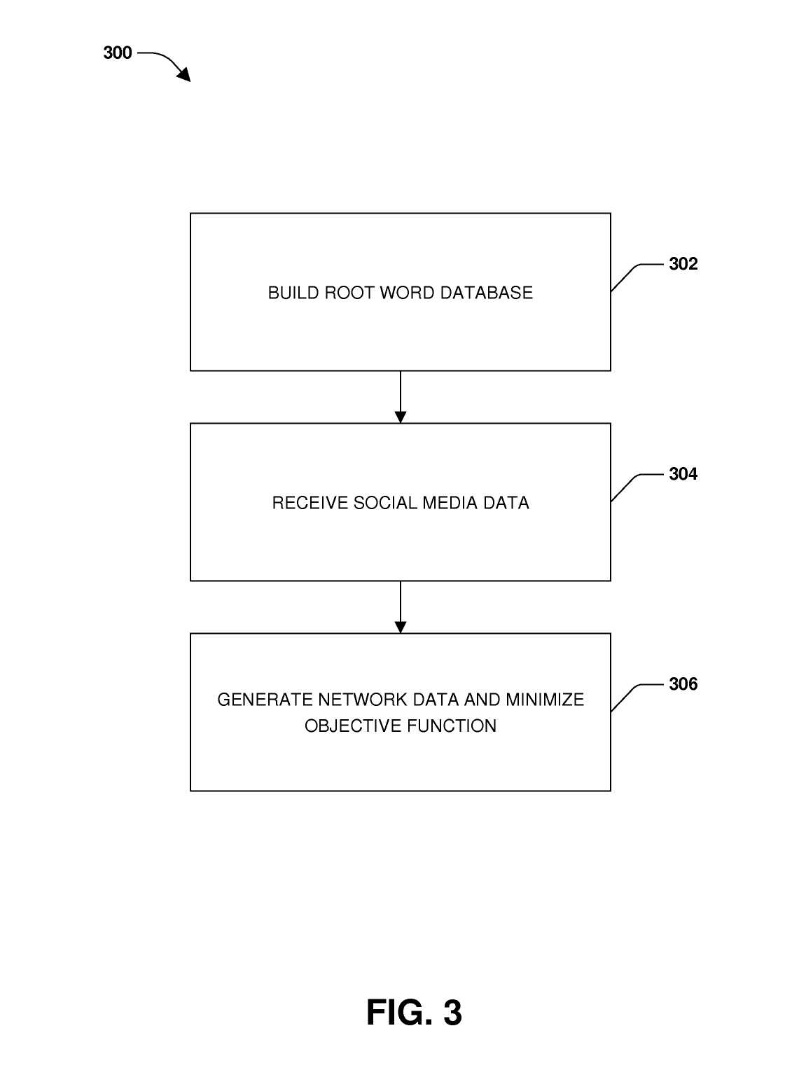

FIG. 3 is an illustration of an example flow diagram of a method 300 for sentiment extraction, according to one or more embodiments. At 302, a root word database may be built. At 304, social media data may be received. At 306, network data may be generated and an objective function may be minimized or solved.

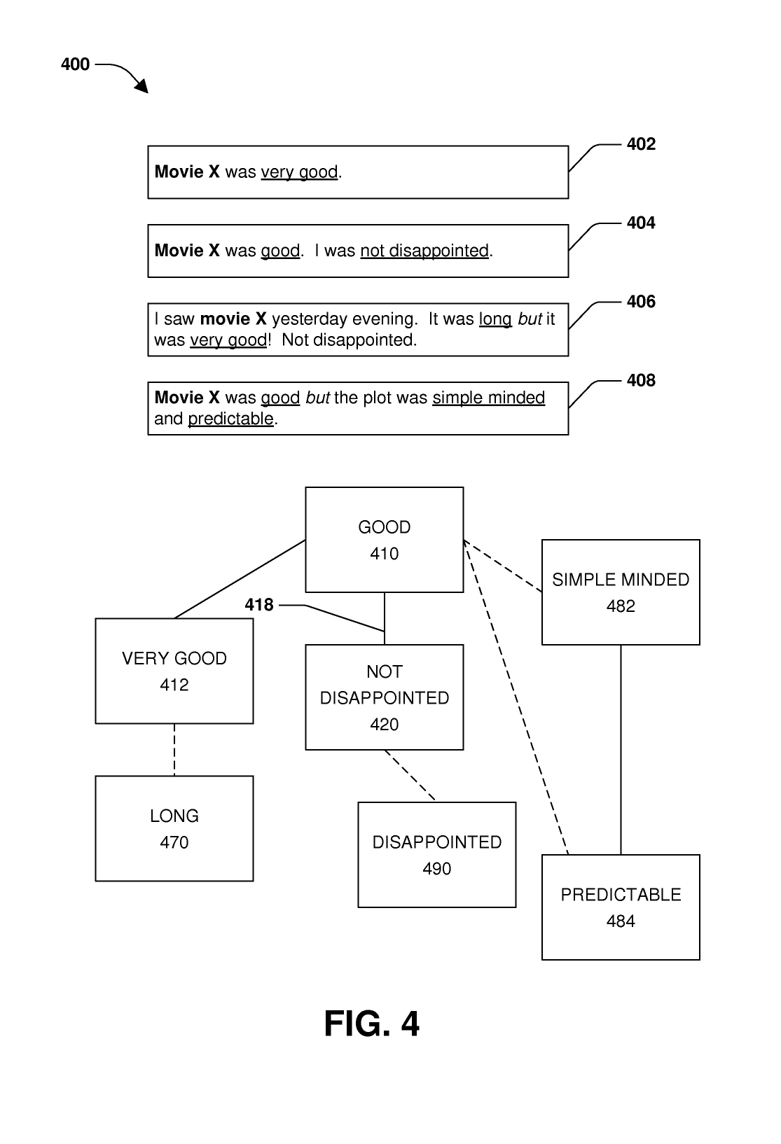

FIG. 4 is an illustration of an example approach or implementation 400 of sentiment extraction, according to one or more embodiments. 402, 404, 406, and 408 are example expressions gathered from one or more social media sources or social media data. As seen in FIG. 4, the target of expressions 402, 404, 406, and 408 are indicated in bold as Movie X. Examples of candidate expressions associated with respective statements or expressions 402, 404, 406, and 408 are illustrated with underline. For example, at 402, “very good” may be among the candidate expressions for that statement or expression 402. Similarly, “good” and “not disappointed” may be candidate expressions for expression 404. “Long” and “very good” may be candidate expressions for expression 406. “Good”, “simple minded”, and “predictable” could be candidate expressions for expression 408.

In FIG. 4, a graph including one or more nodes and one or more edges is shown. For example, one or more nodes of the graph may represent or correspond to one or more of the candidate expressions from statements or expressions 402, 404, 406, and 408. Similarly, one or more of the edges of the graph may represent or correspond to relations, consistency relations (e.g., indicated by solid lines), inconsistency relations (e.g., indicated by dashed or dotted lines), or relationships between respective candidate expressions. For example, for expression 402, node 410 (“good”) and node 412 (“very good”) may be connected with an edge because respective n-grams, terms, or candidate expressions are adjacent or in the same expression 402. For expression 404, node 410 (“good”) and node 420 (“not disappointed”) may be connected by edge 418 for the same or similar reasons. Node 420 (“not disappointed”) and node 490 (“disappointed”) may be connected with a dashed line or edge indicative of an inconsistency relation. The inconsistency relation between nodes 420 and 490 may exist due to the negation language of “not” within the candidate expression “not disappointed” within expression 404. For expression 406, node 470 (“long”) and node 412 (“very good”) may be connected with a dashed edge indicative of an inconsistency relation based on the italicized “but” language (e.g., contrasting conjunction) separating the two candidate expressions and no other candidate expressions and/or negation present, for example. For expression 408, node 410 (“good”) may have an inconsistency relation with node 482 (“simple minded”) for similar reasons. Additionally, node 482 (“simple minded”) and 484 (“predictable”) may be connected with an edge representing a consistency relation, where the consistency relation exists due to no negation or lack of negation associated with the respective nodes 482 and 484.

One or more embodiments may employ various artificial intelligence (AI) based schemes for carrying out various aspects thereof. One or more aspects may be facilitated via an automatic classifier system or process. A classifier is a function that maps an input attribute vector, x=(x1, x2, x3, x4, xn), to a confidence that the input belongs to a class. In other words, f(x)=confidence (class). Such classification may employ a probabilistic or statistical-based analysis (e.g., factoring into the analysis utilities and costs) to prognose or infer an action that a user desires to be automatically performed.

In one or more embodiments, different classifiers may be utilized to facilitate sentiment classification. For example, a machine learning classifier or a lexicon-based classifier (e.g., utilized as a sentiment lexicon) may be employed. A support vector machine (SVM) is another example of a classifier that may be employed. The SVM operates by finding a hypersurface in the space of possible inputs, which the hypersurface attempts to split the triggering criteria from the non-triggering events. Intuitively, this makes the classification correct for testing data that may be similar, but not necessarily identical to training data. Other directed and undirected model classification approaches (e.g., naïve Bayes, Bayesian networks, decision trees, neural networks, fuzzy logic models, and probabilistic classification models) providing different patterns of independence may be employed. Classification as used herein, may be inclusive of statistical regression utilized to develop models of priority.

One or more embodiments may employ classifiers that are explicitly trained (e.g., via a generic training data) as well as classifiers which are implicitly trained (e.g., via observing user behavior, receiving extrinsic information). For example, SVMs may be configured via a learning or training phase within a classifier constructor and feature selection module. Thus, a classifier may be used to automatically learn and perform a number of functions, including but not limited to determining according to a predetermined criteria.

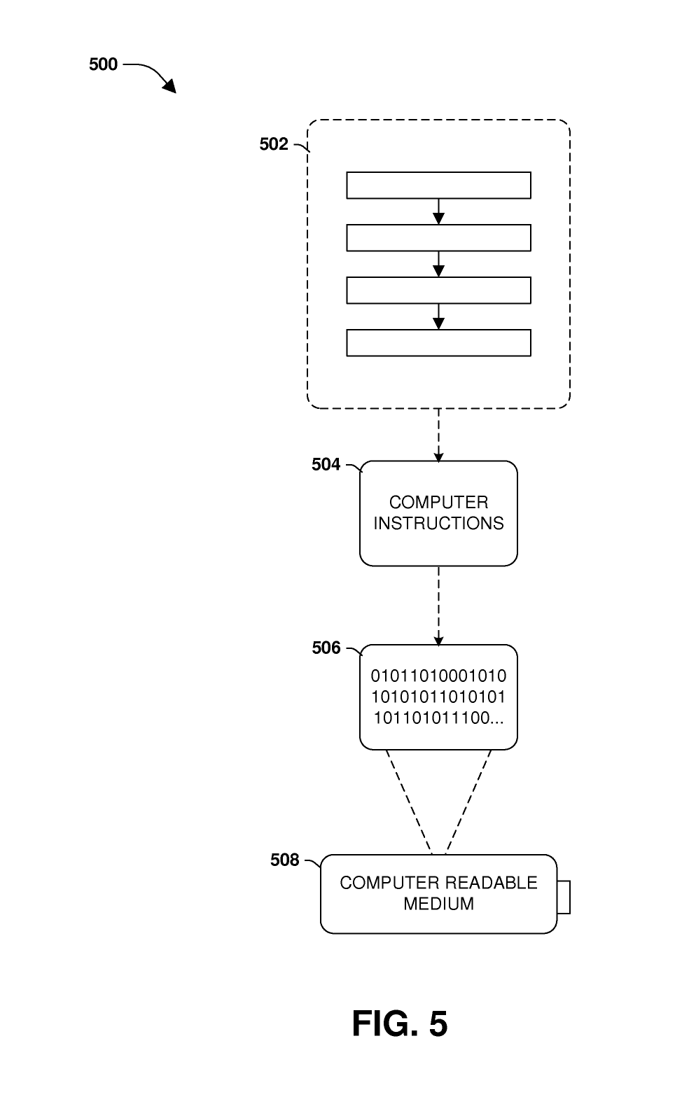

Still another embodiment involves a computer-readable medium including processor-executable instructions configured to implement one or more embodiments of the techniques presented herein. An embodiment of a computer-readable medium or a computer-readable device devised in these ways is illustrated in FIG. 5, wherein an implementation 500 includes a computer-readable medium 508, such as a CD-R, DVD-R, flash drive, a platter of a hard disk drive, etc., on which is encoded computer-readable data 506. This computer-readable data 506, such as binary data including a plurality of zero's and one's as shown in 506, in turn includes a set of computer instructions 504 configured to operate according to one or more of the principles set forth herein. In one such embodiment 500, the processor-executable computer instructions 504 may be configured to perform a method 502, such as the method 200 of FIG. 2 or the method 300 of FIG. 3. In another embodiment, the processor-executable instructions 504 may be configured to implement a system, such as the system 100 of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

FIG. 6 and the following discussion provide a description of a suitable computing environment to implement embodiments of one or more of the provisions set forth herein. The operating environment of FIG. 6 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, embodiments are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 6 illustrates a system 600 including a computing device 612 configured to implement one or more embodiments provided herein. In one configuration, computing device 612 includes at least one processing unit 616 and memory 618. Depending on the exact configuration and type of computing device, memory 618 may be volatile, such as RAM, non-volatile, such as ROM, flash memory, etc., or a combination of the two. This configuration is illustrated in FIG. 6 by dashed line 614.

In other embodiments, device 612 includes additional features or functionality. For example, device 612 may include additional storage such as removable storage or non-removable storage, including, but not limited to, magnetic storage, optical storage, etc. Such additional storage is illustrated in FIG. 6 by storage 620. In one or more embodiments, computer readable instructions to implement one or more embodiments provided herein are in storage 620. Storage 620 may store other computer readable instructions to implement an operating system, an application program, etc. Computer readable instructions may be loaded in memory 618 for execution by processing unit 616, for example.

The term “computer readable media” as used herein includes computer storage media. Computer storage media includes volatile and nonvolatile, removable and non-removable media implemented in any method or technology for storage of information such as computer readable instructions or other data. Memory 618 and storage 620 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by device 612. Any such computer storage media is part of device 612.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 612 includes input device(s) 624 such as keyboard, mouse, pen, voice input device, touch input device, infrared cameras, video input devices, or any other input device. Output device(s) 622 such as one or more displays, speakers, printers, or any other output device may be included with device 612. Input device(s) 624 and output device(s) 622 may be connected to device 612 via a wired connection, wireless connection, or any combination thereof. In one or more embodiments, an input device or an output device from another computing device may be used as input device(s) 624 or output device(s) 622 for computing device 612. Device 612 may include communication connection(s) 626 to facilitate communications with one or more other devices.

According to one or more aspects, a method for sentiment extraction is provided, including receiving one or more expressions, wherein respective expressions include a set of one or more words, wherein one or more of the expressions is associated with a target, extracting one or more candidate expressions from one or more of the expressions, wherein one or more of the candidate expressions includes a subset of the set of one or more words, identifying one or more relationships between one or more pairs of candidate expressions from respective expressions and frequencies of respective relationships across one or more of the expressions, and determining one or more polarities for one or more of the candidate expressions based on one or more positive polarity probabilities for respective candidate expressions, one or more negative polarity probabilities for respective candidate expressions, one or more consistency probabilities for one or more pairs of candidate expressions, one or more inconsistency probabilities for one or more pairs of candidate expressions, and the frequencies of one or more of the relationships between pairs of candidate expressions across one or more of the expressions. The receiving, the extracting, the identifying, or the determining may be implemented via a processing unit.

In one or more embodiments, one or more of the candidate expressions may include a root word. The root word may be a sentiment bearing word. The root word may be a seed word associated with a predetermined positive polarity probability and a predetermined negative polarity probability. One or more candidate expressions may be extracted based on a dependency relation between a root word and a target or a proximity between the root word and the target for a corresponding expression. One or more candidate expressions may be extracted based on one or more n-grams including one or more root words.

One or more relationships may be identified as a consistency relation or an inconsistency relation. One or more inconsistency relations may be identified between a first candidate expression and a second candidate expression based on the first candidate expression including a negation and the first candidate expression including the second candidate expression. One or more inconsistency relations may be identified between a first candidate expression and a second candidate expression based on an expression including the first candidate expression, a contrasting conjunction, and the second candidate expression and a lack of negation applied to both the first candidate expression and the second candidate expression. One or more consistency relations may be identified between a first candidate expression and a second candidate expression based on a lack of negation applied to both the first candidate expression and the second candidate expression.

One or more positive polarity probabilities may be indicative of a probability that a corresponding candidate expression is positive. One or more negative polarity probabilities may be indicative of a probability that a corresponding candidate expression is negative. One or more consistency probabilities may be indicative of a probability that a corresponding pair of candidate expressions have the same polarity. One or more inconsistency probabilities may be indicative of a probability that a corresponding pair of candidate expressions have different polarities.

According to one or more aspects, a system for sentiment extraction is provided, including a root word database, a monitoring component, a parsing component, a relationship component, and an optimization component. The root word database may include one or more root words, wherein one or more of the root words may be seed words. The monitoring component may receive one or more expressions, wherein respective expressions may include a set of one or more words, wherein one or more of the expressions may be associated with a target. The parsing component may extract one or more candidate expressions from one or more of the expressions, wherein one or more of the candidate expressions may include one or more of the root words. The relationship component may identify one or more consistency relationships or one or more inconsistency relationships between one or more pairs of candidate expressions from respective expressions and frequencies of respective relationships across one or more of the expressions. The optimization component may minimize an objective function associated with one or more polarities for one or more of the candidate expressions based on one or more positive polarity probabilities for respective candidate expressions, one or more negative polarity probabilities for respective candidate expressions, one or more consistency probabilities for one or more pairs of candidate expressions, one or more inconsistency probabilities for one or more pairs of candidate expressions, and the frequencies of one or more of the relationships between pairs of candidate expressions across one or more of the expressions. The root word database, the monitoring component, the parsing component, the relationship component, or the optimization component may be implemented via a processing unit.

The parsing component may extract one or more candidate expressions from a corresponding expression by performing sentence splitting on the corresponding expression. The parsing component may determine one or more dependency relations between one or more of the root words and the target based on the sentence splitting. The optimization component may minimize the objective function utilizing a Limited-memory Broyden-Fletcher-Goldfarb-Shanno bound-constrained (L-BFGS-B) algorithm or other similar algorithms. The monitoring component ma receive one or more of the expressions from one or more social media sources or web sources.

According to one or more aspects, the disclosure provides for receiving one or more expressions, wherein respective expressions include a set of one or more words, wherein one or more of the expressions is associated with a target, extracting one or more candidate expressions from one or more of the expressions, wherein one or more of the candidate expressions includes a subset of the set of one or more words, identifying one or more relationships between one or more pairs of candidate expressions from respective expressions and frequencies of respective relationships across one or more of the expressions, and determining one or more polarities for one or more of the candidate expressions based on one or more positive polarity probabilities for respective candidate expressions, one or more negative polarity probabilities for respective candidate expressions, one or more consistency probabilities for one or more pairs of candidate expressions, one or more inconsistency probabilities for one or more pairs of candidate expressions, and the frequencies of one or more of the relationships between pairs of candidate expressions across one or more of the expressions.

Although the subject matter has been described in language specific to structural features or methodological acts, it is to be understood that the subject matter of the appended claims is not necessarily limited to the specific features or acts described above. Rather, the specific features and acts described above are disclosed as example embodiments.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

Although the disclosure has been shown and described with respect to one or more implementations, equivalent alterations and modifications will occur based on a reading and understanding of this specification and the annexed drawings. The disclosure includes all such modifications and alterations and is limited only by the scope of the following claims.

What is claimed is:

1. A method for sentiment extraction, comprising:
receiving one or more expressions, wherein respective expressions comprise a set of one or more words, wherein one or more of the expressions is associated with a target;
extracting one or more candidate expressions from one or more of the expressions, wherein one or more of the candidate expressions comprises a subset of the set of one or more words;
identifying one or more relationships between one or more pairs of candidate expressions from respective expressions and frequencies of respective relationships across one or more of the expressions; and
determining one or more polarities for one or more of the candidate expressions based on one or more positive polarity probabilities for respective candidate expressions, one or more negative polarity probabilities for respective candidate expressions, one or more consistency probabilities for one or more pairs of candidate expressions, one or more inconsistency probabilities for one or more pairs of candidate expressions, and the frequencies of one or more of the relationships between pairs of candidate expressions across one or more of the expressions,
wherein the receiving, the extracting, the identifying, or the determining is implemented via a processing unit.

2. The method of claim 1, wherein one or more of the candidate expressions comprises a root word.

3. The method of claim 2, wherein the root word is sentiment bearing.

4. The method of claim 2, wherein the root word is a seed word associated with a predetermined positive polarity probability and a predetermined negative polarity probability.

5. The method of claim 2, wherein extracting one or more of the candidate expressions is based on a dependency relation between the root word and the target or a proximity between the root word and the target for a corresponding expression.

6. The method of claim 1, wherein extracting one or more of the candidate expressions based on one or more n-grams comprising one or more root words.

7. The method of claim 1, wherein one or more of the relationships is identified as a consistency relation or an inconsistency relation.

8. The method of claim 1, comprising identifying one or more inconsistency relations between a first candidate expression and a second candidate expression based on the first candidate expression comprising a negation and the first candidate expression comprising the second candidate expression.

9. The method of claim 1, comprising identifying one or more inconsistency relations between a first candidate expression and a second candidate expression based on:
an expression comprising the first candidate expression, a contrasting conjunction, and the second candidate expression; and
a lack of negation applied to both the first candidate expression and the second candidate expression.

10. The method of claim 1, comprising identifying one or more consistency relations between a first candidate expression and a second candidate expression based on a lack of negation applied to both the first candidate expression and the second candidate expression.

11. The method of claim 1, wherein one or more of the positive polarity probabilities is indicative of a probability that a corresponding candidate expression is positive.

12. The method of claim 1, wherein one or more of the negative polarity probabilities is indicative of a probability that a corresponding candidate expression is negative.

13. The method of claim 1, wherein one or more of the consistency probabilities is indicative of a probability that a corresponding pair of candidate expressions have the same polarity.

14. The method of claim 1, wherein one or more of the inconsistency probabilities is indicative of a probability that a corresponding pair of candidate expressions have different polarities.

15. A system for sentiment extraction, comprising:
a root word database comprising one or more root words, wherein one or more of the root words are seed words;
a monitoring component receiving one or more expressions, wherein respective expressions comprise a set of one or more words, wherein one or more of the expressions is associated with a target;
a parsing component extracting one or more candidate expressions from one or more of the expressions, wherein one or more of the candidate expressions comprises one or more of the root words;
a relationship component identifying one or more consistency relationships or one or more inconsistency relationships between one or more pairs of candidate expressions from respective expressions and frequencies of respective relationships across one or more of the expressions; and
an optimization component minimizing an objective function associated with one or more polarities for one or more of the candidate expressions based on one or more positive polarity probabilities for respective candidate expressions, one or more negative polarity probabilities for respective candidate expressions, one or more consistency probabilities for one or more pairs of candidate expressions, one or more inconsistency probabilities for one or more pairs of candidate expressions, and the frequencies of one or more of the relationships between pairs of candidate expressions across one or more of the expressions,
wherein the root word database, the monitoring component, the parsing component, the relationship component, or the optimization component is implemented via a processing unit.

16. The system of claim 11, wherein the parsing component extracts one or more candidate expressions from a corresponding expression by performing sentence splitting on the corresponding expression.

17. The system of claim 16, wherein the parsing component determines one or more dependency relations between one or more of the root words and the target based on the sentence splitting.

18. The system of claim 11, wherein the optimization component minimizes the objective function utilizing an L-BFGS-B algorithm.

19. The system of claim 11, wherein the monitoring component receives one or more of the expressions from one or more social media sources or web sources.

20. A computer-readable storage medium comprising computer-executable instructions, which when executed via a processing unit on a computer performs acts, comprising:
receiving one or more expressions, wherein respective expressions comprise a set of one or more words, wherein one or more of the expressions is associated with a target;
extracting one or more candidate expressions from one or more of the expressions, wherein one or more of the candidate expressions comprises a subset of the set of one or more words;
identifying one or more relationships between one or more pairs of candidate expressions from respective expressions and frequencies of respective relationships across one or more of the expressions; and
determining one or more polarities for one or more of the candidate expressions based on one or more positive polarity probabilities for respective candidate expressions, one or more negative polarity probabilities for respective candidate expressions, one or more consistency probabilities for one or more pairs of candidate expressions, one or more inconsistency probabilities for one or more pairs of candidate expressions, and the frequencies of one or more of the relationships between pairs of candidate expressions across one or more of the expressions.
